(19) United States
(12) Patent Application Publication
(10) Pub. No.: US 2019/0084509 A1
(43) Pub. Date: Mar. 21, 2019

(54) BATTERY BACKUP SYSTEM

(71) Applicants: Gerard M. Toscani, Moorestown, NJ (US); Efrain Rodriguez, Bordentown, NJ (US)

(72) Inventors: Gerard M. Toscani, Moorestown, NJ (US); Efrain Rodriguez, Bordentown, NJ (US)

(21) Appl. No.: 16/134,412

(22) Filed: Sep. 18, 2018

Related U.S. Application Data
(60) Provisional application No. 62/560,744, filed on Sep. 20, 2017.

(51) Int. Cl. B60R 16/033; B60L 11/18; H02J 9/06

(52) U.S. Cl. CPC B60R 16/033; B60L 11/1861; H02J 9/061; B60L 11/1816

(57) ABSTRACT

A backup battery system has an add-on battery module intended for semi-permanent to permanent pairing with an existing lead-acid vehicle battery. The system provides a backup to the battery if the battery becomes depleted or unserviceable due to age, damage, or sub-freezing temperatures. The system is installed alongside the existing vehicle battery and has no impact on operations unless it automatically detects that the battery has become depleted and is in need of an assist, in which case the system will “wake up” and jump start the vehicle. The system is charged by the vehicle electrical system in parallel with the vehicle battery as needed, but only when the vehicle is running.

### RELATED APPLICATION

This application claims the benefit of Application Ser. No. 62/560,744, filed on Sep. 20, 2017.

### BACKGROUND OF THE INVENTION

The normal means of electrically “jumping” a depleted or dead vehicle battery is by utilizing jumper cables to connect a fully charged battery of a second vehicle with the deficient battery. Recently, separate jump starter units have advantageously been used to charge a dead or depleted battery. However, difficulties obviously arise when another vehicle, jumper cables, or a jump starter is not available. There are currently no independent battery charging systems in existence to address this troublesome circumstance.

### SUMMARY OF THE INVENTION

It is thus the object of the present invention to overcome the disadvantages and limitations of existing battery charging systems by providing a unique vehicle battery backup system which ensures that the vehicle battery can be fully charged at all times, without the need for outside jumper cables or jump starters.

This and other objects are accomplished by the present invention, a backup battery system comprising an add-on battery module intended for semi-permanent to permanent pairing with an existing lead-acid vehicle battery. The system provides a backup to the battery if the battery becomes depleted or unserviceable due to age, damage, or sub-freezing temperatures. The system is installed alongside the existing vehicle battery and has no impact on operations unless it automatically detects that the battery has become depleted and is in need of an assist, in which case the system will “wake up” and jump start the vehicle. The system is charged by the vehicle electrical system in parallel with the vehicle battery as needed, but only when the vehicle is running.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is a circuitry schematic showing the main components of the battery backup system of the present invention.

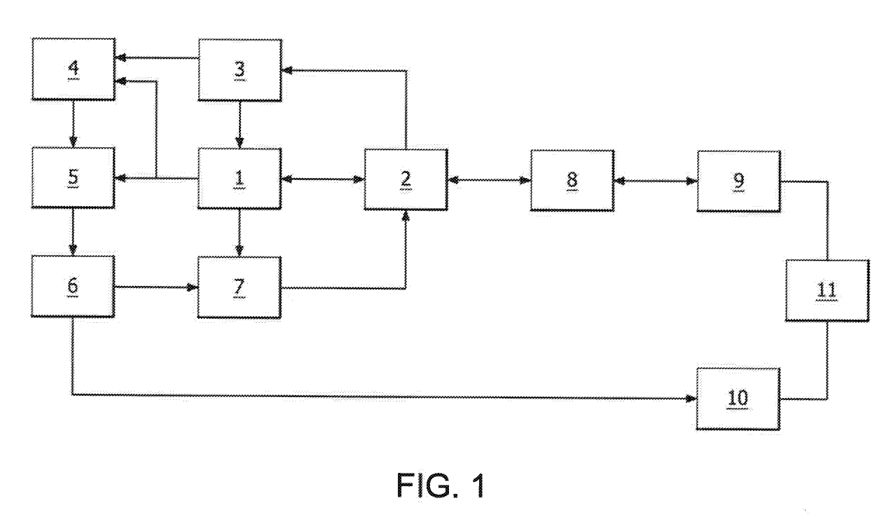

### DETAILED DESCRIPTION OF THE INVENTION

The battery backup system of the present invention is a self-contained module comprising one external conductor 9 for connection to the positive terminal of battery 11, and one external conductor 10 for connection to the negative terminal of the vehicle battery. Main Controller Unit (MCU) 1 is an 8-bit PIC16F15378 which operates at an extremely low power “sleep” mode, periodically “waking up” to sample the system's parameters. MCU 1 will also auto-detect the proper installation and perform all system status checks. Once safely installed, MCU 1 will enter a low power deep “sleep” mode.

Ring Terminal Interface (RTI) 2 contains analog sensing, amplification, and crank detect circuitry. The signals from RTI 2 are forwarded to MCU 1 where this information is digitized. A crank detect circuit will send an interrupt signal to MCU 1 when the need for a jump assist is automatically detected. This interrupt signal will “wake up” MCU 1, which will cause the MCU to sense its environment and turn on jump start relay 7. This allows jump start electric current to safely flow to vehicle battery 11.

Jump start electric current is provided from a fast discharge jump start battery 6 designed for 600 cranking amp delivery. Jump start battery 6 has very specific cell monitoring, cell balancing, and temperature profile parameters which must be maintained to ensure long life use. Battery monitoring sensor 5 monitors and controls proper charge and battery health. If jump start battery 6 falls below 80% of capacity, MCU 1 will “wake up” and begin to charge the jump start battery. MCU 1 will turn on charge switch 3 when it senses that jump start battery 6 is less than 80% and that the vehicle is running.

The battery backup system of the present invention will charge in parallel with vehicle battery 11. MCU 1 will turn off charge switch 3 when the battery is fully charged. This will disconnect the system from the vehicle's electrical system until it is required to automatically assist vehicle battery 11 again. Charging of jump start battery 6 is performed by jump start battery charger 4. It will recharge any 4 amp rate.

### LISTING OF PARTS AND FUNCTIONS OF THE BATTERY BACKUP SYSTEM

Main Controller Unit 1
   PIC16F15375
   Thermal management, detection of cranking demand for current
   Determination of need for charging
   Determination of system “health”
Ring Terminal Interface 2
   Sense Crank Assist
   Sense voltage, current, temp
Charge Switch 3
   This is a MOSFET switch
BQ24630 LiFePo Jump Start Battery Charger 4
   Rated for 4 ampere maximum charge current
Battery Monitor System BMS BQ3451—5
   Constant current/constant voltage controlled rate charger
   Cell balancing
   Voltage and current limit monitoring
   Estimation of state of charge
LiFePO battery 3 Q24630—6
   Four LiFePO₄ cells in 4S1P configuration to provide 12.8/13.2V
Jump Start Relay 7
Resetable Fuse 8
   Failsafe for catastrophic event protection
+Term 9
   10 gage, red wire with crimped circular terminal
−Term 10
   10 gage, black wire with crimped circular terminal

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A battery backup system for automatically providing electric current for charging a depleted vehicle battery, said system comprising:
a positive terminal battery connection;
a negative terminal battery connection;
a main controller unit for determining the electric current charging requirement of the vehicle battery;
a jump start battery electrically connected to the positive terminal battery connection and the negative battery terminal connection for providing jump start electric current to the vehicle battery;
a jump start relay electrically connected between the main controller unit and the jump start battery;
whereby upon determining that jump start electric current is required for charging the vehicle battery, the main controller unit turns on the jump start relay to permit the flow of jump start electric current from the jump start battery to the positive terminal battery connection and the negative terminal battery connection to thereby charge the vehicle battery.

2. The battery backup system as in claim 1 further comprising crank detect circuitry which signals the main controller unit that the vehicle battery requires electric current charging, whereby upon receipt of the signal, the main controller unit turns on the jump start relay to permit the flow of jump start electrical current from the jump start battery to the positive terminal battery connection and the negative terminal battery connection.

3. The battery backup system as in claim 1 further comprising a battery monitor sensor to monitor the electrical condition of the jump start battery, whereby when the battery monitor sensor determines that the condition of the jump start battery is below 80% of its capacity, the main controller unit will turn on a charge switch in the system to permit the flow of electric current from a jump start battery charger to the jump start battery.

4. The battery backup system as in claim 2 further comprising a battery monitor sensor to monitor the electrical condition of the jump start battery, whereby when the battery monitor system determines that the condition of the jump start battery is below 80% of its capacity, the main controller unit will turn on a charge switch in the system to permit the flow of electric current from a jump start battery charger to the jump start battery.

5. The battery backup system as in claim 4 in which all components identified in claims 1, 2, and 4, are located in a self-contained module.

6. The battery backup system as in claim 1 in which the main controller unit further determines whether the system is properly installed and when the vehicle battery is fully charged.
